(19) United States
(12) Patent Application Publication
(10) Pub. No.: US 2003/0101062 A1
(43) Pub. Date: May 29, 2003

(54) Large scale procurement of energy efficiency resources

(75) Inventor: William Stevens Taber JR., San Anselmo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Princeton Development Corporation, San Anselmo, CA

(21) Appl. No.: 09/964,133

(22) Filed: Sep. 25, 2001

Related U.S. Application Data
(60) Provisional application No. 60/235,995, filed on Sep. 27, 2000.

(51) Int. Cl. G06F 17/60

(52) U.S. Cl. 705/1

(57) ABSTRACT

The present invention provides a variation of the ESCO business model which incorporates elements of a large scale procurement of energy efficiency resources on behalf of a number of host customers. The resulting program greatly increases the cost-efficiency of the process and, therefore, it also increases the economic benefits to the participating host customers. The present invention is set forth in greater detail in the Detailed Description that follows.

### CROSS-REFERENCE TO RELATED APPLICATIONS

This application claims priority to U.S. Provisional Application Serial No. 60/235,995, filed on Sep. 27, 2000, the disclosure of which is incorporated herein by reference in its entirety for all purposes.

### BACKGROUND OF THE INVENTION

### Conventional Techniques for Procuring Energy Efficiency

A. Customer Investment

For many years, facility-related equipment upgrade projects whose merits included improved energy efficiency or reduced maintenance requirements or both, and which therefore would reduce operating costs, were sold to customers on a cash basis, with the customer investing the capital cost and receiving reduced operating costs as the return on that investment. This approach is shown in FIG. 1.

With this approach, the customer acts as the developer of the project and takes the development risk. Among the development risks which the customer may incur are the following: 1) implementation cost overruns; 2) energy efficiency gains less than predicted; 3) fluctuations in the cost of supplied energy, affecting the economic benefits even if the energy benefits are as predicted; and 4) fluctuations in currency exchange rates, if the equipment and the supplied energy are procured in different currencies.

The above-described approach above may be modified to cause the provider of the equipment, or a third party, to warrant the performance of the equipment or to take any of the risks described above. To the extent that the warrantor is financially able to deliver these warranties or take these risks, this effectively protects the customer from the risks transferred. This approach is shown in FIG. 2.

B. Third Party Financed Performance Contract

A salient feature of the approach described above is that the capital cost of the project is borne by the customer. This is a potentially severe constraint, since most businesses prefer to invest their capital in their core business activity rather than in reducing the operating costs of their facilities. Therefore, an approach was developed to permit energy efficiency providers to invest their own capital, or third party capital, in such equipment upgrade projects, permitting the host customer to invest nothing, experience only positive cash flow, and incur no risk. This approach is described in FIG. 3 (for capital provided by a third party, in this case a lessor).

Generally speaking, in this approach, the operating cost savings experienced by the customer are measured using measurement techniques agreed to by the parties. For example, such calculation techniques are often based on the International Performance Measurement and Verification Protocol. The Customer then pays a stipulated portion of the operating costs savings to the third party investor as the return on the investor's capital.

A variation on this approach isolates the third party investor from the customer, which may have certain advantages and disadvantages, depending on the legal and business environment. This approach is shown in FIG. 4.

The approaches described above have supported the development of what is often referred to as the Energy Services industry or the ESCO industry. The growth of the ESCO industry has been stimulated by the availability of financial incentives for investments in energy efficiency provided by electric and gas utilities and paid for by a portion of the utility's revenues. In simplified terms, the ESCO development process normally proceeds as follows.

As part of the sales cycle, the ESCO prepares at its own risk and expense an “investment grade audit”. To do so, the ESCO sends an auditor to the customer's facility; the auditor typically has a general technical and economic knowledge of various kinds of energy efficient equipment. The auditor identifies all opportunities for installing energy efficient equipment which meet the investment criteria of the ESCO (for example, minimum operating cost savings as a percentage of capital cost).

Guided by the investment grade audit, the ESCO determines in what energy efficient equipment it is willing to invest (or in which it can induce a third party to invest). When the ESCO has marshaled the resources necessary to install the equipment, it proceeds to do so, using its own forces or third party contractors. Once the installation is completed, the ESCO proceeds to measure the performance of the equipment and receive payments from the customer accordingly.

There are important advantages to the ESCO business model, in particular that it enables customers who lack the staff or financial resources or the technical expertise to acquire energy efficiency resources independently to do so in cooperation with an ESCO. The ESCO business model, when it succeeds, is a win-win approach. However, there are some important weaknesses in the ESCO business model: 1) ESCOs typically need to have high margins (over the direct cost of the energy efficient equipment installed) to be profitable; 2) ESCOs typically have limited buying power in the market; and 3) ESCOs frequently use conservative, “padded” estimating procedures of both capital cost and performance to mitigate risk. Since the audit will guide the ESCO's investment decisions, the auditor usually makes conservative assumptions about capital cost and energy performance.

Furthermore, the auditor is usually a generalist, since he or she must consider and analyze energy efficient equipment of many different kinds during an audit (lighting equipment, space conditioning equipment, motors and drives, power generation equipment, etc.) Therefore, the auditor is usually inclined to be even more conservative, reflecting the auditor's lack of depth of experience with any specific type of equipment. Because of the above factors, ESCOs typically need “short-payback” measures to support their business model.

C. Aggregation of Host Customers

As the ESCO industry has proven itself in the marketplace, various entities with access to, or the opportunity to represent, large numbers of potential customers of the ESCO industry have attempted to achieve economies of scale. There are two approaches to doing so which constitute prior art with respect to this invention:

C1. Consolidated Selection of an ESCO

In many cases, an electric or gas utility, a joint powers authority, or a similar entity representing multiple potential customers of ESCOs will conduct a solicitation and selection process on behalf of a large number of their customers or constituents. The entity will select a single ESCO or a small number of ESCOs. The potential host customers are then free to contract directly with the selected ESCO, following the normal ESCO business model described above. This approach has the advantage that each customer does not need to solicit and select an ESCO, but it achieves no large economies of scale, since the inherent disadvantages of the ESCO model are still in effect. An example of this approach is the selection of the ESCO known as Energy Masters, Inc. by the Northern California Power Agency. The NCPA is a joint powers authority which conducts wholesale procurement activities on behalf of fifteen municipal utilities in northern California. As a result of the ESCO solicitation by the NCPA, the fifteen constituent members of the NCPA can contract directly with Energy Masters in providing energy efficiency services to their respective retail customers.

C2. Volume Procurement of Equipment

In other cases, a procuring entity representing multiple potential users of energy efficient equipment may issue a solicitation for such equipment (constrained by specifications of quality) on a unit price basis. Since the procuring entity potentially represents a large volume of product sales, equipment providers may compete aggressively for this business. Therefore, the procuring entity may be able to deliver very low unit prices to the equipment users which it represents. An example of this approach is the annual procurement of lighting products by the State of California on behalf of all State agencies and local public jurisdictions in California. The solicitation typically draws very low unit prices for such products as fluorescent lamps and ballasts. This approach has the limitation that it provides only equipment.

### SUMMARY OF THE INVENTION

The present invention provides a variation of the ESCO business model which incorporates elements of a large scale procurement of energy efficiency resources on behalf of a number of host customers. The resulting program greatly increases the cost-efficiency of the process and, therefore, it also increases the economic benefits to the participating host customers. The present invention is set forth in greater detail in the Detailed Description that follows.

### BRIEF DESCRIPTION OF THE DRAWINGS

FIG. 1 is a graphical representation of an energy procurement process in which the customer bears the burden of procurement.

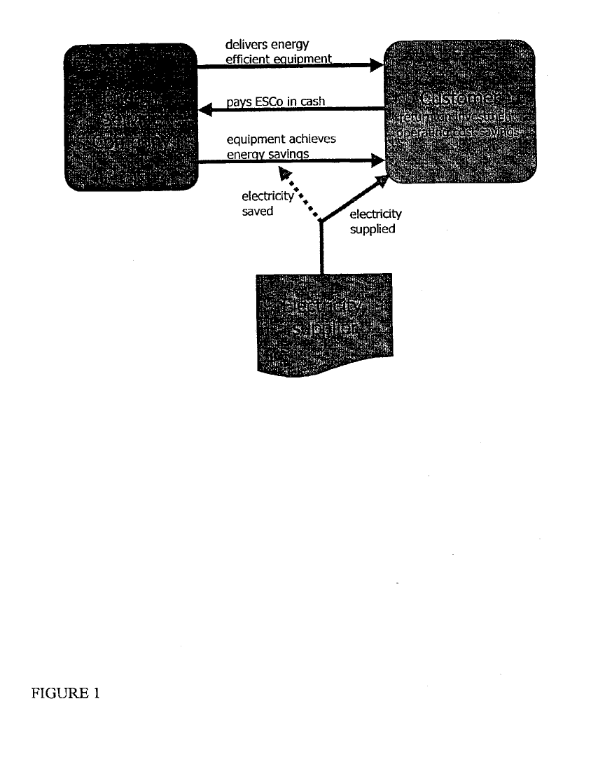

FIG. 2 is a graphical representation of an energy procurement process in which a third party assumes the risks of the procurement.

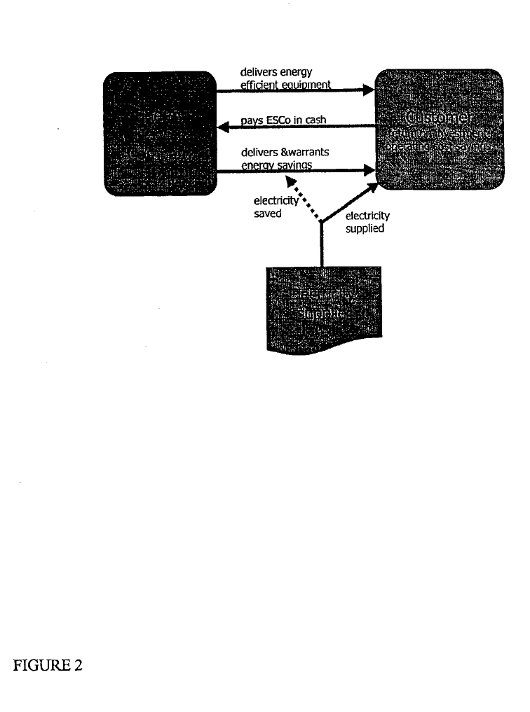

FIG. 3 is a graphical representation of an energy procurement process in which a third party lessor provides the capital for the procurement.

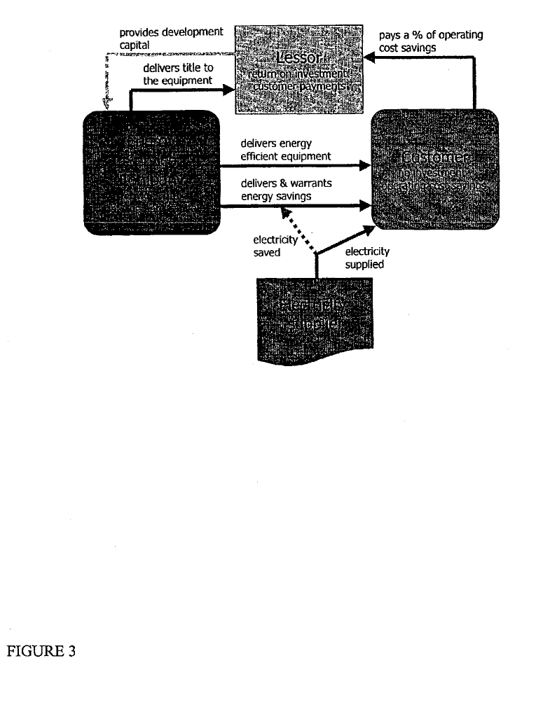

FIG. 4 is a graphical representation of an energy procurement process in which a third party assumes the risks of the procurement and is isolated from the customer.

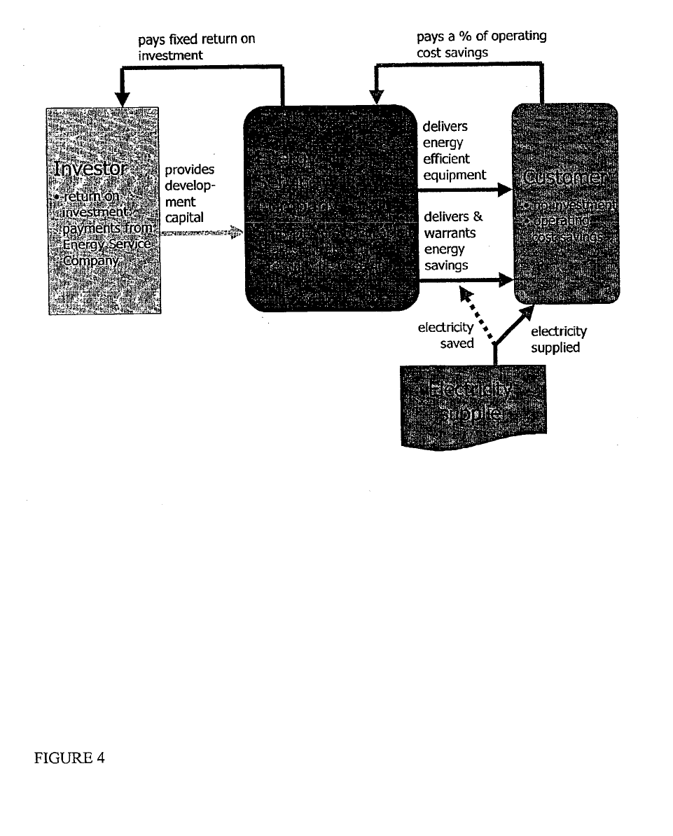

FIG. 5 is a graphical representation of the equivalence of procured energy and saved energy.

FIG. 6 is a graphical representation of an exemplary method of the invention in which currency conversion is utilized.

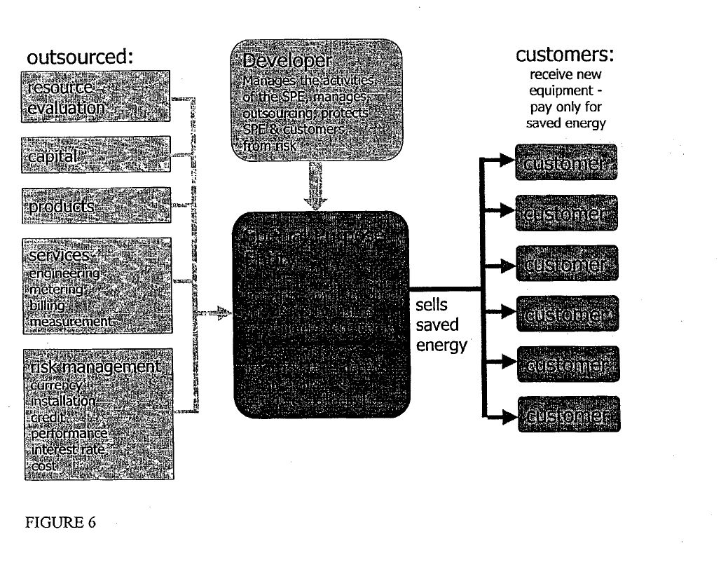

### DETAILED DESCRIPTION OF THE INVENTION AND THE PREFERRED EMBODIMENTS

The present invention is readily understood by considering the program from the point of view of the implementing entity (“the Sponsor”) and from the point of view of the participating customers (“the Customer”).

A. Summary of the Sponsor's View

In a preferred embodiment, the sponsor procures energy efficiency resources from suppliers of energy efficient products and related services, converts those resources into saved energy, and sells the saved energy to the customer. The sponsor is preferably procuring at wholesale prices and selling at retail prices. This is analogous to the function of an energy distribution company, which procures, for example, electric power on a wholesale basis from power generators, then distributes it and sells it to its retail customers.

B. Summary of the Customer's View

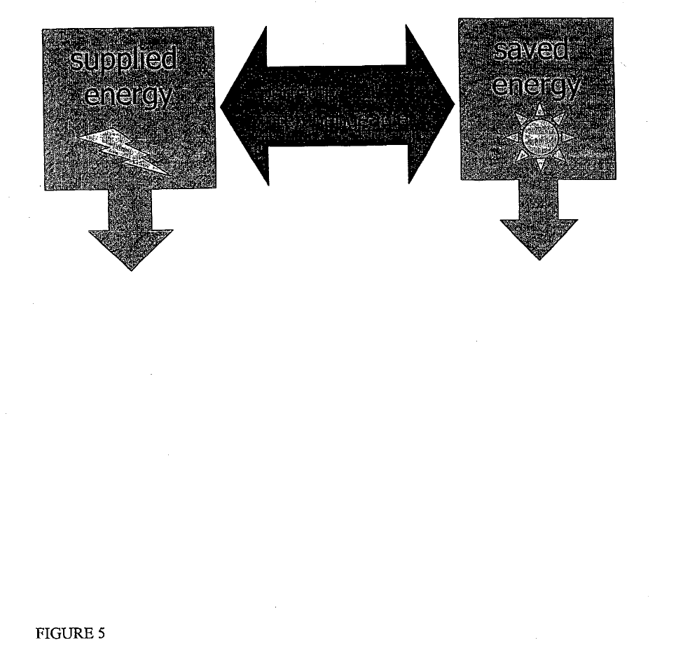

In a preferred embodiment, the customer procures saved energy on an interchangeable basis with supplied energy. Fundamentally, there is no inherent economic difference from the customer's point of view between supplied and saved energy (FIG. 5). In the application of this program, however, saved energy can be much less expensive than supplied energy.

C. Customer's View: How the Program Works

In the practice of the present invention, the Customer acquires new energy-consuming equipment, including lighting, air conditioning, combined heat and power equipment, and other equipment, as identified by the Resource Evaluation (see, below). There is no up front cost to or capital expenditure by the Customer. The Customer preferably pays only for the saved energy as it is delivered (analogous to the way customer pays for supplied energy). The Customer gets new equipment, at no up front cost, benefits from lower energy costs and from lower maintenance costs (since the old equipment is replaced by new equipment, and has the risks assumed by others).

D. Sponsor's View: a High-Volume Procurement and Resale of Saved Energy

From the Sponsor's point of view, there are various elements to the high-volume procurement:

D1. Equipment Procurement

There are preferably separate procurements of equipment by technology area (e.g., separate procurements for lighting equipment, air conditioning equipment ground loops, combined heat and power, UPS, power conditioning, etc.) Each of these procurements work similarly to the program described above, wherein the State of California procures lighting equipment on behalf of its agencies and local public jurisdictions. As in the case of the California procurement, the high volumes result in improved unit prices. Where appropriate, cost and performance guarantees are incorporated into the procurement specifications. The program preferably utilizes the data acquired during the procurement activities to guide the Resource Acquisition (see, below).

D2. Procurement of Services

There are preferably separate procurements of services by service area (engineering by technology type, risk management, metering, billing, logger installation and data download, data analysis, installation inspection, commissioning etc.). The high volumes provide favorable prices, and cost and performance guarantees are procured with the services as appropriate.

D3. Resource Evaluation

Each participating Customer preferably receives a program-specific Resource Evaluation. An exemplary Resource Evaluation identifies and evaluates all energy efficiency measures. In this sense, it is analogous to the investment grade audit conducted during the ESCO process, but it is qualitatively different in its function and its economic effect. The evaluation process preferably interacts directly and in real time with the procurement process, cutting audit costs, reducing cost and performance uncertainty, cutting cycle time.

In an exemplary embodiment, each technology at a site is evaluated by a specialist in that technology, rather than a generalist conducting an audit of all energy end uses. The specialist performs the audit efficiently since he or she is surveying a very large number of sites. Preferred specialists are those which bring a high degree of expertise and working efficiency to the task of evaluating the energy efficiency resource specific to his or her area of technological expertise. In another preferred embodiment, the cost and performance data used in the Resource Evaluation are based on the actual prices which resulted from the equipment procurement, rather than an auditor's conservative estimate of prices.

The Resource Evaluation is different from an ESCO-style investment-grade audit. As discussed above, ESCOs typically have high margins, have little buying power in the market, and use conservative, “padded” estimating procedures of both capital cost and performance to mitigate risk. Therefore, ESCOs typically need short-payback measures to support their business model. On the other hand, a preferred program-specific Resource Evaluation: 1) is profitable overall even with thin margins; 2) has enormous buying power in the market; 3) mitigates cost and performance risk through the timing of the procurement process, without “padding” the projections; and 4) acquires every feasible source of efficiency, not just the short-payback items.

D4. Financing

The financing of the program will preferably be off-balance sheet for the customer; the customer pays strictly for energy delivered (i.e., energy saved). In addition, the financing for the program can be off-balance sheet for the Sponsor, structured either as non-recourse project financing (analogous to the international power project financing model) or carried by a special purpose entity. Financing will preferably be at a very low interest rate (e.g., 3% to 4% per year for procurements on behalf of public customers, 5% to 6% for private customers), because of the size of the procurement and the options which are available to large-scale financing activities (such as a “low-floater” instrument). The financing is preferably credit-enhanced for best trading.

D5. Utility Incentives

Most states require energy utilities to offer financial incentives for investments in energy efficiency. The program preferably includes negotiating master incentive payments from each affected utility to underwrite the program as a whole. In addition to improving the performance of the program for the Sponsor and the Customers, the incentives enable the affected utilities to acquire high-quality energy efficiency resources very reliably and cost-efficiently. From the utility's point of view, this is a superior resource acquisition procurement technique to many of the programs now in place in the utility industry. This also gives the affected utilities the chance to “wear the white hats” and thereby garner favorable public and customer relations.

D6. Consolidated Billing

The saved and supplied energy is preferably invoiced to the Customer on a single bill. As discussed above, metering and billing services can be procured competitively.

D7. Risk Management

Effective risk management is a factor in driving down the cost of capital for the program. Risk management services are preferably procured competitively from third parties; the program risks need not be borne by the Sponsor. In addition, the high volume of resources acquired under the program lends itself to statistical techniques to mitigate performance fluctuations and variability inexpensively (crudely know as the Law of Off-Setting Errors).

D8. Resource Measurement

The program preferably measures saved energy accurately, just as a meter measures supplied energy. Accurate measurement supports making saved and supplied energy interchangeable. In addition, accurate measurement enhances the value of the efficiency resource to grid operators, stakeholders, legislators, customers. In an exemplary embodiment, the present program uses the International Performance Measurement and Verification Protocol for measurement techniques. Measurement protocols can achieve extremely high economies of scale (see, for example, Taber, et. al. Reaching for High-Hanging Fruit, Cost-Effective Measurement of Demand Side Bids, Proceedings of the 1998 ACEEE Summer Study on Energy Efficiency in Buildings, American Council for an Energy Efficient Economy, Washington D.C., August 1998).

D9. Aggregation and Monetization of Carbon and Other Emissions Credits

The program preferably conducts the aggregation and monetization of the reduction in emissions of carbon and other atmospheric pollutants resulting from the program. While the market is only beginning to develop, there is a growing and active world market for carbon credits. The program will preferably conduct one or more of the following activities to capture this value stream.

Quantifying the emission reductions. There is an emerging standard calculation method wherein the average fuel mix in the country in which the project is located is used as the basis for estimating the tons of carbon reduced, etc.

Registering the emission reductions. There is an emerging process where the relevant federal agency in the country where the program is conducted is requested to officially note these reductions, and contractually allocating the legal rights to these credits to the Sponsor.

In summary, the present technique for procuring and delivering energy efficiency resources is qualitatively different from and better than existing techniques.

1. A method of procuring energy efficient end user equipment and deployment of said equipment at multiple end user sites by an implementing entity, and sale of energy to each of said multiple end user sites, wherein said energy comprises energy saved at the end user site by said deployment, said method comprising:
(a) auditing by said implementing entity of energy using equipment at said multiple end user sites, said audit identifying energy using equipment at said sites that is a candidate for replacement with energy efficient equipment performing an equivalent task, said replacement resulting in saved energy;
(b) procuring by said implementing entity of said energy efficient end user equipment from a supplier of said equipment;
(c) deploying by said implementing entity of an energy saving replacement for least one said candidate for replacement with said energy efficient equipment at no cost to said end users;
(c) measuring by said implementing entity of said saved energy at said sites using a method of measurement agreed upon by said end users and said implementing agency;
(d) selling by said implementing entity of said saved energy to said end users at a price that is less than the price of energy purchased from an energy generating company.

2. The method according to claim 1, wherein said deployment at said multiple end user sites is performed in a coordinated manner.

3. The method according to claim 1, wherein said procurement incorporates performance specifications for energy efficiency into terms governing said procurement.

4. The method according to claim 1, further comprising procuring a service pertinent to said deployment of energy efficient equipment and sale of said saved energy, wherein said service is a member selected from the group consisting of resource evaluation, equipment installation, financing, engineering, risk management, metering, billing, logger installation and data download, data analysis, installation inspection, commissioning and combinations thereof.

5. The method according to claim 4, wherein said service is procured separately for each equipment type.

6. The method according to claim 1, wherein said auditing is performed by an auditor specializing in evaluating the potential energy saving for a selected type of said energy saving equipment rather than a generalist energy auditor.

7. The method according to claim 1, wherein actual cost, rather than estimated cost, of said energy saving equipment is utilized to project financial feasibility for said deployment by said implementing entity.

8. The method according to claim 1, wherein actual energy saving, rather than estimated energy saving, of said energy saving equipment is utilized to project financial feasibility for said deployment by said implementing entity.

9. The method according to claim 3, wherein said procurement utilizes actual energy saving, rather than estimated energy saving, of said energy saving equipment is utilized to project financial feasibility for said deployment by said implementing entity.

10. The method according to claim 1, further comprising methods to reduce financial risk to said implementing entity.

11. The method according to claim 1, wherein said procurement is performed in a volume sufficient to increase profit of said sale of saved energy to a preselected amount.

12. The method according to claim 1, wherein said procurement is performed in a volume sufficient to provide said implementing entity access to modes of financing said procurement, said deployment and combinations thereof that are not available at procurement levels below said volume.

13. The method according to claim 12, wherein said mode of financing is credit enhancement.

14. The method according to claim 13, wherein said credit enhancement reduces the cost for said implementing entity of borrowing money for said procurement.

15. The method according to claim 12, wherein said mode of financing is includes a tax-exempt, floating rate.

16. The method according to claim 1, wherein said implementing entity receives an incentive from an energy utility company to undertake said procurement, said deployment and combinations thereof.

17. The method according to claim 16, wherein said incentive is received from more than one of said multiple end user sites.

18. The method according to claim 1, wherein said procurement and deployment improves a member selected from the group consisting of reliability of the energy using equipment, quality of the energy using equipment, public relations value of the energy using equipment and combinations thereof.

19. The method according to claim 18, wherein the improvement is judged by an objective standard set by an energy utility company.

20. The method according to claim 1, wherein compensation for said sale of saved energy is received from said end user per unit of energy saved.

21. The method according to claim 1, in which more than one type of energy saving equipment is acquired, thereby increasing diversity of energy saving end user equipment and mitigating risk of low energy saving from one or more type of said energy saving end user equipment.

22. The method according to claim 1, wherein risk of inadequate energy saving equipment performance associated with one or more item of said energy saving end user equipment is undertaken by a party other than said implementing entity or said end user.

23. The method according to claim 1, wherein a credit, which is a member selected from environmental benefits, carbon credits, air pollution credits and combinations thereof for each of said multiple end user sites are aggregated by said implementing entity.
